(19) United States
(12) Patent Application Publication
(10) Pub. No.: US 2014/0337465 A1
(43) Pub. Date: Nov. 13, 2014

(54) ASSET MANAGEMENT SYSTEM FOR APPLICATIONS AND METHODS OF DISTRIBUTING AND MANAGING STATIC ASSETS FOR APPLICATIONS

(71) Applicant: NVIDIA CORPORATION, Santa Clara, CA (US)

(72) Inventor: Cass Everitt, Austin, TX (US)

(73) Assignee: Nvidia Corporation, Santa Clara, CA (US)

(21) Appl. No.: 13/891,509

(22) Filed: May 10, 2013

(51) Int. Cl. H04L 29/08

(52) U.S. Cl. CPC H04L 67/10
USPC 709/217

(57) ABSTRACT

A method of providing an application to a user device, a method of managing static assets for applications and an asset management system are disclosed herein. In one aspect, the method of providing an application to a user device includes: (1) receiving a request from a user device to download an application, (2) sending a manifest of the application to the user device, the manifest including a list of asset keys for the application wherein each of the asset keys uniquely corresponds to a static asset of the application and (3) compiling, by a processor, a transmit list of the static assets that are absent from the user device.

### TECHNICAL FIELD

This application is directed, in general, to delivering applications to computing devices and, more specifically, to managing the assets of applications.

### BACKGROUND

Computing devices, such as mobile devices, perform many functions for users, including providing communication and entertainment. For example, many computing devices provide the ability to communicate by text, communicate by voice, connect to the web, watch videos, make videos, take pictures, play games, etc. To perform these different functions, the computing devices execute different types of applications. These applications are often downloaded from remote servers such as an online application store. Typically, the applications are downloaded as a large bundle of binary data, such as in a ZIP file, to the requesting computing device. The computing device then unwraps the bundle in an install process.

### SUMMARY

In one aspect, a method of providing an application to a user device is disclosed. In one embodiment, the method includes: (1) receiving a request from a user device to download an application, (2) sending a manifest of the application to the user device, the manifest including a list of asset keys for the application wherein each of the asset keys uniquely corresponds to a static asset of the application and (3) compiling, by a processor, a transmit list of the static assets that are absent from the user device.

In another aspect, a method of managing static assets for applications is disclosed. In one embodiment, this method includes: (1) computing, by a processor, a unique key for a static asset of an application and (2) storing the static asset and the unique key in a searchable database, wherein the unique key indicates a location of the static asset in the database.

In yet another aspect, an asset management system is disclosed. In one embodiment, the asset management system includes: (1) an interface configured to communicate with user devices, (2) a first database including applications and manifests, wherein each of the manifests corresponds to one of the applications and includes a list of unique asset keys that correspond to static assets of the one of the applications and (3) a second database including the static assets and the unique asset keys, wherein the unique asset keys indicate a location of the static assets in the database.

### BRIEF DESCRIPTION

Reference is now made to the following descriptions taken in conjunction with the accompanying drawings, in which:

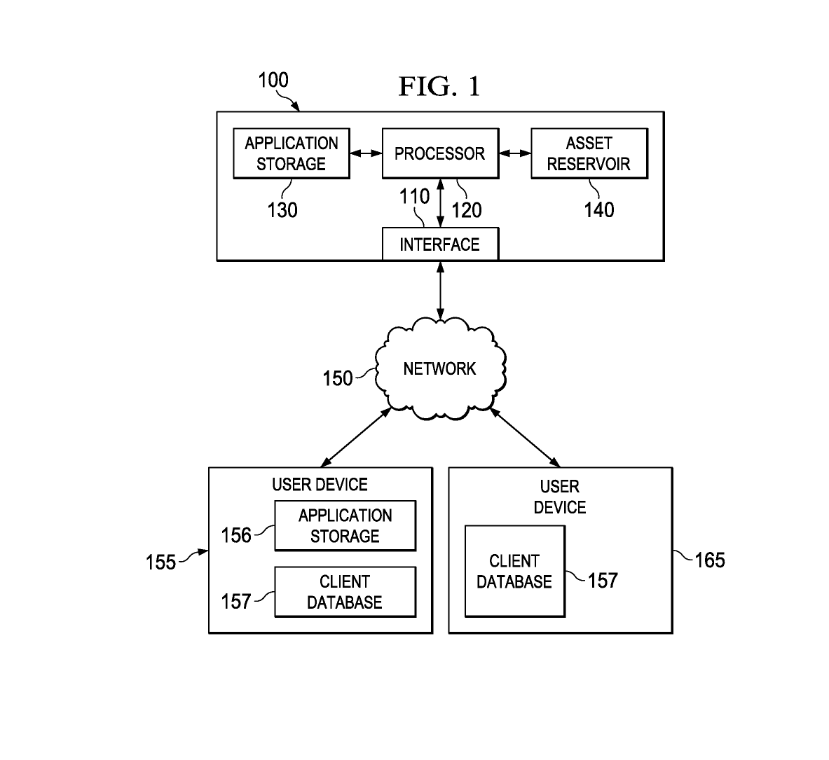

FIG. 1 illustrates a system diagram of an embodiment of an asset management system constructed according to the principles of the disclosure;

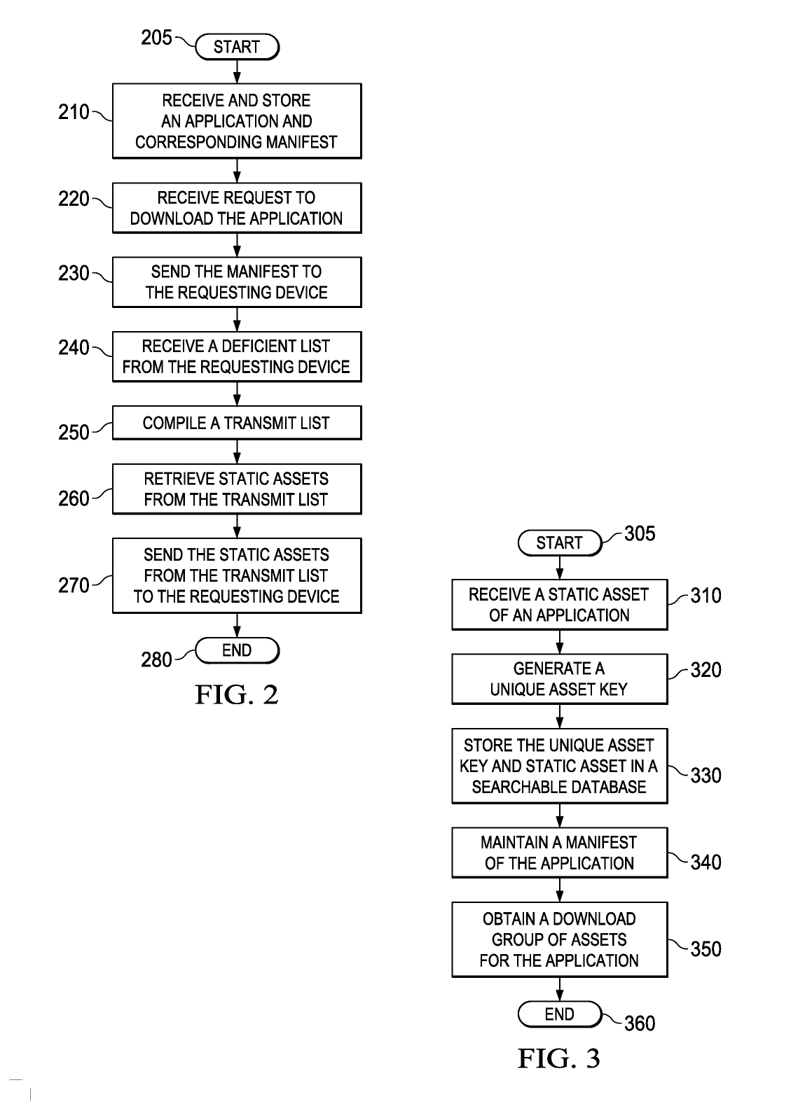

FIG. 2 illustrates a flow diagram of an embodiment of a method of providing an application to a user device carried out according to the principles of the disclosure; and

FIG. 3 illustrates a flow diagram of an embodiment of a method of managing static assets for applications carried out according to the principles of the disclosure.

### DETAILED DESCRIPTION

The disclosure provides a static asset distribution and management scheme that improves the delivery of applications to user devices. Instead of downloading an application as a single self-contained bundle of binary data, e.g., a single monolithic block of data, the disclosure provides systems and methods that identify static assets associated with an application, store the static assets and deliver identified static assets along with the application. The static assets can be stored in an asset reservoir that can be globally searched based on unique asset keys that are generated from the particular corresponding static asset itself. The asset keys can be generated to prevent collisions even when the static assets are stored in distributed databases. Thus, the disclosure provides for delivering a requested application as a combination of the application and the associated static assets. This allows downloading only changed parts of the application and its assets.

In contrast to conventional downloading of applications, the disclosed embodiments deliver an application and static assets as a collection of compressed data. For example, in response to a request for delivery of an application, the application, static asset A, static asset B, etc., are delivered together as individually compressed data files. As such, compilation times can be decreased when transmitting and receiving since the resident data is not continually re-compressed and resent. Additionally, download times for an application are also reduced. This is especially true in embodiments where the user device identifies static assets that are needed for executing the application but are accessible by the user device. These accessible static assets do not need to be downloaded with the application. In one embodiment, the static assets are accessible since they are stored on the requesting user device itself. In another embodiment, the static assets are accessible via a peer device coupled thereto. An accessible static asset of a requesting user device, therefore, is a static asset that is stored on the requesting user device or can be retrieved from another location besides the asset reservoir. Regardless if a static asset is retrieved from the asset reservoir or from a peer device, permission for delivery of the static asset may be required. The permission or authority for delivery can be based on if the requesting user device has paid for access to the static asset. In one embodiment, permission can be granted based on purchasing the application from an asset management system. If retrieving from a peer device, the permission can be delivered to the peer device allowing the peer device to send the static asset to the requesting user device.

An application as used herein is a computer program or programs designed for use by an end user or computing device. In some embodiments, an application includes both systems programs or software and end-user programs or software. A “static asset” in the context used herein is an asset of an application in which the content and properties remain constant. For example, a static asset can be a texture program, a sampler program, a shader program, a buffer object, audio data, etc., whose content and properties will never change. Since these assets are static, an identifier can be generated from the object data itself that uniquely describes the object. In one embodiment, a short (e.g., 512 bit) identifier is computed from the object data itself. The generated identifier is referred to herein as an “asset key”. Because the asset never changes, the corresponding asset key never changes. Accordingly, the static assets can be cached, e.g., in an asset reservoir and/or a distributed database, and referred to by their corresponding asset key. Similarly, collections of static assets are themselves static and have similar properties. Thus, an asset key can be generated for a collection of static assets and used to access that collection.

In addition to a central or globally accessible database, such as an asset reservoir, the disclosure also provides a distributed database that employs the asset keys for accessing the static assets on-demand. The distributed database can include databases located, for example, in various peer devices of a requesting computing device. As noted above, access can be restricted to a static asset based on whether a user or requesting device has permission, such as a license, to the content. Again, because the content is static, once rights are confirmed, any server, such as an asset reservoir, or distributed database, such as a peer device, could provide the content of the static asset. The requesting user device can verify the validity of the received static asset by re-computing the asset key from the content data. Validity can also be similarly verified by the asset management system and a peer device.

When a static asset is accessible from a distributed database, the disclosed asset management system does not need to ship that static asset with the requested application. Additionally, if multiple applications make use of a common static asset, the asset management system can only keep one copy of the static asset for all to share. The single copy can be stored in asset reservoir; thus reducing storage space. This is particularly attractive in the context of application point releases that update their executable program and perhaps a handful of assets, but the majority of assets are essentially unchanged. With such an asset management system as disclosed herein, used for example by an online application store, updates would consume a tiny fraction of the bandwidth and storage compared to existing methods and systems.

In addition to a collection of static assets, the disclosure also provides derived assets. For example, in the case of shader programs, the source to the shader program is device independent. However, the compiled machine microcode and the driver-specific microcode are not device independent. By combining the unique asset key of the shader program with a fingerprint describing the device and its system and driver software, a new derived asset key can be defined. The derived asset key is also static, because it only depends on static data. The content associated with the derived asset key referred to herein as a derived asset, however, is non-static. This is especially true considering the compiler and machine-specific microcode since improvements to the compiler that generates machine-specific microcode are possible and desirable. System software updates and similar improvements would invalidate derived assets, which would then need to be re-cached. In one embodiment, a provider of a derived asset would have the ability to invalidate derived assets. For example, a compiler that generates an “improved” derived asset may not even be on the system using the derived asset. So to be able to send an improved derived asset the provider needs to be able to explicitly invalidate the earlier version of or the existing derived asset. In some embodiments, software updates on a particular system will implicitly invalidate an earlier version of a derived asset.

Considering shaders for an example of derived assets, shaders are expressed in OpenGL as a high level program and delivered to the driver of computing devices when operating. Currently, shader programs are compiled after received at the device. The shader program is a static asset. Instead of downloading the shader program that is then compiled by the computing device, a derived asset can be generated based on the fingerprint of the computing device and the shader program. The derived asset, therefore, represents a compiled program that can be downloaded for specific computing devices. A derived asset key can be generated from the shader program and the fingerprint of the computing device and used to obtain an optimal or more optimal version of the shader program for a particular known device.

The static asset management disclosed herein also employs a manifest with each application. In one embodiment, the manifest is provided by and communicated by the application. The manifest lists the static assets that an application needs when executing. This would allow for the computation of size-of-download and pre-downloading all content needed to run the application. This process would also allow checking for derived assets such as pre-compiled shader microcode and to deliver those during application downloads as well. The derived assets can be stored with the static assets or in another designated memory.

The effect of this kind of asset management system disclosed herein fundamentally changes the way that application static assets are managed and downloaded, and apart from making life much simpler from the distribution perspective, offers the opportunity for assets to be loaded directly from an Application Program Interface (API). In the case of cached assets, the process of loading could be dramatically reduced by no longer invoking a compiler/optimizer at run-time. Similarly for large data assets, mechanisms in the driver and system software could be enabled to dramatically speed up loading time. In a world where long load times are a real problem, this style of static asset management would offer significant value.

Turning now to the Figures that illustrate different embodiments, FIG. 1 illustrates a system diagram of an embodiment of an asset management system 100 constructed according to the principles of the disclosure. The asset management system 100 is configured to deliver applications and related static assets to user devices for execution thereof. In one embodiment, the asset management system 100 is implemented on a server. In other embodiments, the asset management system 100 can be implemented on multiple servers or other types of processors. The asset management system 100 includes an interface 110, a processor 120, application storage 130 and an asset reservoir 140. Each of these components of the asset management system 100 can be implemented as part of a server or a server and related database. In one embodiment, the asset management system 100 may be an online application store. As such, the asset management system 100 can include other components not illustrated but typically include in an online application store.

FIG. 1 also illustrates a network 150, a first user device 155 and a second user device 165 to illustrate the operating environment of the asset management system 100. As used herein, the first user device 155 is a requesting user device and the second user device 165 is a peer device having a database that is part of the distributed database. One skilled in the art will recognize that multiple user devices can be connected to the asset management system 100 and that in some embodiments the first user device 155 can be the peer device and the second user device 165 can be the requesting device.

The interface 110 is a communication interface that is configured to communicate with user devices. The interface 133 includes the necessary circuitry to transmit and receive data via, for example, a communications network. As such, the interface 110 is configured to communicate via communication protocols including, for example, networking protocols such as Ethernet, Wi-Fi or Internet protocol. The interface 110 is configured to communicate via wireless or wired connections.

The interface 110 is configured to receive requests for applications from user devices, such as the first user device 155. The interface 110 is also configured to receive uploads of applications. In addition to the applications, the interface 110 is configured to receive a manifest for each of the applications. In some embodiments, the interface 110 receives static assets and asset keys for the applications. In other embodiments, the processor 120 generates the asset keys from static assets uploaded with the applications. An application developer may upload the applications, the manifests, the static assets, derived assets and corresponding the asset keys to the asset management system 100. Upon receipt, the applications and manifests are stored in the application storage 130 and the asset keys and the static assets are stored in the asset reservoir 140. The processor 120 can be configured to direct storing of the various uploads.

The processor 120 is also configured to respond to a request from the user device 155, to download an application by generating a download group of the static assets associated with the application. The static assets identified for the download group can be less than the total number of static assets associated with the application. In other words, the manifest for the application could include five asset keys that identify five static assets and the processor only fetches two of the five static assets for the download group because the other three static assets are accessible by the user device 155. In one embodiment, at least one of the three static assets can be obtained from the user device 165 while the other two static assets could already be stored on the user device 155. In one embodiment, the processor 120 is configured to generate the download group in response to a deficient list from the at least one of the user devices. The deficient list for an application is generated by the user device 155 after receiving the manifest for that application from the asset management system 100. The deficient list indicates the static assets that are needed from the asset management system 100, i.e., the static assets that need to be downloaded with the application.

The application storage 130 is a database that stores the various applications of the asset management system 100. In addition to the application, the application storage 130 also stores the manifest for each of the applications. The asset reservoir 140 is a searchable database that is configured to store the static assets and the asset keys. The asset reservoir 140 is configured such that the asset keys indicate the location of the corresponding static assets stored therein. In one embodiment, the asset keys and the static assets are arranged in a table. The application storage 130 and the asset reservoir 140 can be stored on a conventional memory or memories such as used with an application store. In one embodiment, the memory or memories are associated with or part of a server.

The communications network 150 is a conventional network that is used by the asset management system 100 to transmit and receive data, including uploads, downloads, requests for applications, deficient lists, etc. As illustrated in FIG. 1, the user devices 155 and 165 can communicate with the static asset management system 100 via the communications network 150. The interface 110 and the user devices 155, 165, include the necessary circuitry to communicate over the communications network 150 employing the proper networking protocol.

The first user device 155 and the second user device 165 are computing devices configured to perform various functions including communicating with the asset management system 100 over the communication network 150. Computing devices can be smart phones, tablets, clamshells, game devices, etc., that include at least one processor and memory. In some embodiments at least one of the first user device 155 and the second user device 165 is a mobile communication device. One skilled in the art will also understand that the first and second user devices 155, 165, include other components that are typically included in such devices including a display, user interface, power supply, communications interface, etc. In one embodiment, both the first user device 155 and the second user device 165 are configured to execute applications. First user device 155 includes an application storage 156 and a client database 157. The application storage 156 is configured to store applications and corresponding manifests. The client database 157 is configured to store local programs, drivers, etc., that are typically included in a client database of a user device. Additionally, the client database 157 is configured to store asset keys and static assets pairs. As such, at least a portion of the client database 157 is configured like the asset reservoir 140. The application storage 156 and the client database 157 can be stored on a conventional memory or memories of the first user device 155.

The second user device 165 also includes a client database 167. The client database 167 is configured to store local programs, drivers, etc., that are typically included in a client database of a user device. Additionally, the client database 167 is configured to store asset keys and static assets pairs. As such, at least a portion of the client database 167 is similarly configured as the asset reservoir 140. The client database 167 can be stored on a conventional memory or memories of the second user device 165.

FIG. 2 illustrates a method 200 of providing an application to a user device carried out according to the principles of the disclosure. In one embodiment, the method 200 is implemented as a series of operating instructions, stored on a non-transitory computer readable medium, that direct the operation of a processor when initiated. The method 200 or at least a portion thereof may be carried out by an asset management system, such as asset management system 100. As an example, the asset management system 100 will be referred in the below discussion of the method 200. The method 200 begins in a step 205.

In a step 210, an application and a corresponding manifest are received and stored. In one embodiment, the application and manifest are received from a developer of the application that uploads the application along with the corresponding manifest. The application and manifest can be received by the interface 110 and stored in the application storage 130.

A request to download the application is received in a step 220. The request can be received from a user device, such as a smart phone, a game player, a computing pad, or another type of computing device. The request can be received via a communications network and conform to the applicable network protocol. In one embodiment, the request is received from first user device 155 via communications network 150 and processed by the processor 120.

In a step 230, a manifest of the application is sent to the requesting user device. The manifest includes a list of asset keys for the application wherein each of the asset keys uniquely corresponds to a static asset of the application. The processor 120 can retrieve the manifest from the application storage 130 and send the manifest to the requesting user device 155 via the interface 110 and the communications network 150.

A deficient list is received from the user device in a step 240. In one embodiment, the deficient list is received after the manifest is received by the requesting user device and an inventory of the accessible static assets is determined by the requesting user device. As such, the deficient list includes the static assets listed on the manifest that are deemed inaccessible by the requesting user device and are needed to be downloaded with the application. Thus, the static assets are not stored locally on the user device, such as in the client database 157 of the user device 155 or accessible from the peer device, user device 165 or the client database 167 thereof, of the distributed database coupled to the user device 155 via a local network or another type of wireless or wired connection.

In some embodiments, the requesting user device can obtain one or more of the static assets from a peer device. In one embodiment, permission for delivering the static asset has to be received before the static asset can be sent. The permission can be provided from the asset management system to the peer device before sending the static asset. The static asset can then be delivered from the peer device to the requesting user device via the connecting network or connection. As such, user device 165 can deliver a static asset to user device 155 after receiving permission from the asset management system 100. The permission can be directly received from the asset management system 100 (i.e., delivered to the user device 165 without going through the user device 155) or can be delivered to the user device 165 through the user device 155.

In a step 250, a transmit list of the static assets that are inaccessible from the requesting user device is compiled. The transmit list includes the static assets needed to be downloaded with the application. In one embodiment, the processor 120 compiles the transmit list from the asset keys of the deficient list.

The static assets from the transmit list are then retrieved from an asset reservoir in a step 260. The static assets are retrieved according to their asset keys. In one embodiment, the static assets are stored in a compressed format on the asset reservoir and retrieved in this format for delivery. In one embodiment, a static asset to be retrieved can be a collection of static assets. As such, a single asset key can correspond to a collection of assets that are static. In another embodiment, an asset key used for retrieval is a derived asset key that points to a derived asset.

In a step 270, the static assets from the transmit list are sent to the user device. The static assets can be sent with the requested application. Instead of a monolithic block of digital data, the static assets and application are sent as a group of individually compressed data blocks. The static assets from the transmit list can be sent as a download group. In some embodiments, the download group can include a non-static asset, i.e., a derived asset.

Today applications usually ship with all their assets in a self-contained bundle. This has the satisfying property of allowing a progress bar to show how long the download will take and verifying that enough storage exists to hold the application and all of its assets. In, for example an online application store with the kind of asset management as disclosed herein, the request application communicates a manifest of the assets that it needs. This allows the asset management system to compute the size-of-download and pre-downloading all content needed to run the application. This process also allows checking for derived assets such as pre-compiled shader microcode and to deliver those during application download as well.

The method 200 ends in a step 280.

FIG. 3 illustrates a method 300 of managing static assets for applications carried out according to the principles of the disclosure. The method 300 or at least a portion thereof can be carried out by an asset management system such as the asset management system 100 in FIG. 1. In one embodiment, the method 300 is implemented as a series of operating instructions, stored on a non-transitory computer readable medium, that direct the operation of a processor when initiated. The method 300 begins in a step 305.

In a step 310, a static asset is received. The static asset can be received from an original upload of the application. In some embodiments, the static asset for one application is received from an upload of another application. Thus, the static asset is a shared static asset that can be used by more than one application. In some embodiments, the static asset is identified as a static asset upon receipt. For example, the asset management system 100 can receive an application including its assets and then identify the assets that are static assets. These static assets can then be stored in a database such as the asset reservoir 140.

In a step 320, a unique asset key for the static asset is generated. The unique asset key can be generated by a processor that computes the unique key employing, for example, a hash algorithm and the static asset itself. In some embodiments, the unique asset key is generated using only the asset itself. As such, self-validation of an asset key can be performed. In some embodiments, unique asset keys are computed for multiple static assets of the application. In one embodiment, a derived asset key is generated for a derived asset. In other embodiments, an asset key for a collection of static assets is generated.

In a step 330, the static asset and the unique asset key are stored in a searchable database. The unique asset key is used to indicate a location of the static asset in the database. In one embodiment the static asset is stored in the database in a compressed format. More than one static asset and corresponding unique asset key can be stored in the searchable database. Additionally, static assets stored in the searchable database can be associated with more than one application.

A manifest for the application is maintained in a step 340. The manifest can be maintained by a processor of the asset management system. The manifest can be updated based on uploads of the application. The manifest can be sent to a requesting device for the requesting device to use to determine static assets that are needed for download.

In a step 350, a download group of assets for the application is obtained. In one embodiment, the download group can be compiled in response to a request to download the application. The download group of assets are obtained or fetched according to their unique asset keys. In one embodiment, the download group only includes static assets identified as needed by a user device requesting the application. In some embodiments, the download group includes derived assets. A deficient list can be employed to determine the download group. The method 300 ends in a step 360.

A portion of the above-described apparatuses, systems or methods may be embodied in or performed by various, such as conventional, digital data processors or computers, wherein the computers are programmed or store executable programs of sequences of software instructions to perform one or more of the steps of the methods. The software instructions of such programs may represent algorithms and be encoded in machine-executable form on non-transitory digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods, or functions of the apparatuses described herein. As discussed with respect to disclosed embodiments, a server can include the necessary hardware, software or a combination thereof that is configured to perform the described functions. In other embodiments, a user device can include the necessary hardware, software or a combination thereof configured to perform the described functions.

Portions of disclosed embodiments may relate to computer storage products with a non-transitory computer-readable medium that have program code thereon for performing various computer-implemented operations that embody a part of an apparatus, system or carry out the steps of a method set forth herein. Non-transitory used herein refers to all computer-readable media except for transitory, propagating signals. Examples of non-transitory computer-readable media include, but are not limited to: magnetic media such as hard disks, floppy disks, and magnetic tape; optical media such as CD-ROM disks; magneto-optical media such as floptical disks; and hardware devices that are specially configured to store and execute program code, such as ROM and RAM devices. Examples of program code include both machine code, such as produced by a compiler, and files containing higher level code that may be executed by the computer using an interpreter.

Those skilled in the art to which this application relates will appreciate that other and further additions, deletions, substitutions and modifications may be made to the described embodiments.

What is claimed is:

1. A method of providing an application to a user device, comprising;
receiving a request from a user device to download an application;
sending a manifest of said application to said user device, said manifest including a list of asset keys for said application wherein each of said asset keys uniquely corresponds to a static asset of said application; and
compiling, by a processor, a transmit list of said static assets that are absent from said user device.

2. The method of providing as recited in claim 1 further comprising sending said static assets from said transmit list to said user device.

3. The method of providing as recited in claim 1 further comprising retrieving said static assets from an asset reservoir based on said asset keys.

4. The method of providing as recited in claim 3 wherein said static assets are stored in a compressed format on said asset reservoir.

5. The method of providing as recited in claim 1 further comprising receiving a deficient list from said user device after sending said manifest, wherein said deficient list includes said static assets that are absent from said user device.

6. The method of providing as recited in claim 1 further comprising providing permission for said user device to obtain one of said static assets from a peer database.

7. The method of providing as recited in claim 1 wherein said static asset is a derived static asset.

8. The method of providing as recited in claim 1 further comprising receiving and storing said application and said manifest before receiving said request.

9. A method of managing static assets for applications, comprising:
computing, by a processor, a unique key for a static asset of an application; and
storing said static asset and said unique key in a searchable database, wherein said unique key indicates a location of said static asset in said database.

10. The method as recited in claim 9 further comprising storing said static asset in said database in a compressed format.

11. The method as recited in claim 9 further comprising receiving said static asset.

12. The method as recited in claim 9 further comprising generating a derived asset key for a derived static asset and storing said derived asset key in said searchable database.

13. The method as recited in claim 9 further comprising computing unique keys for multiple static assets of said application and storing said multiple static assets and said unique keys in said searchable database.

14. The method as recited in claim 13 further comprising maintaining a manifest for said application that includes said unique keys.

15. The method as recited in claim 14 further comprising generating a download group of said multiple static assets in response to a request to download said application, wherein said download group only includes static assets identified as needed by a user device requesting said application.

16. The method as recited in claim 9 further comprising storing additional static assets and corresponding unique keys in said searchable database, wherein said additional static assets are associated with another application that is different than said application.

17. An asset management system, comprising:
an interface configured to communicate with user devices;
a first database including applications and manifests, wherein each of said manifests corresponds to one of said applications and includes a list of unique asset keys that correspond to static assets of said one of said applications; and
a second database including said static assets and said unique asset keys, wherein said unique asset keys indicate a location of said static assets in said database.

18. The asset management system as recited in claim 17 further comprising a processor configured to respond to a request from at least one of said user devices to download an application by generating a download group of said static assets associated with said application per said corresponding manifest.

19. The asset management system as recited in claim 18 wherein said processor is configured to generate said download group in response to a deficient list from said at least one of said user devices.

20. The asset management system as recited in claim 17 wherein said second database is configured to include derived asset keys that correspond to derived assets and a collection of static assets that correspond to a single one of said unique asset keys.
